(19) United States
(12) Patent Application Publication
(10) Pub. No.: US 2008/0171799 A1
(43) Pub. Date: Jul. 17, 2008

(54) Synthesis of Polymer Foam Using Sonic Energy

(76) Inventors: Lindsay Redmond, Essex, VT (US); Rebecca Christianson, Waltham, MA (US); Rebecca Scholl, West Long Branch, NJ (US)

Correspondence Address: Lindsay Redmond, 2 Sage Circle, Essex, VT, 05452, US

(21) Appl. No.: 11/624,212

(22) Filed: Jan. 17, 2007

(51) Int. Cl. C08J 9/00

(52) U.S. Cl. 521/149; 521/50

(57) ABSTRACT

A process for synthesizing polymer foam. Polymer foams can be created through the direct mixing of chemicals. Prior research has shown that greater uniformity can be created by physically mixing the components of the foam before and during the foaming process. This invention covers the creation of polymer foam utilizing the mixing energy created by sound waves (herein referred to as sonication) prior to and during the foaming process. The result of physical mixing through sonication is a more uniform foam.

### FIELD OF THE INVENTION

The present invention relates generally to the polymer foam processing, and more particularly to rigid foam.

### BACKGROUND OF THE INVENTION

This present invention pertains to the process of the synthesis of polymer foam for buoyant marine purposes. U.S. Pat. No. 6,593,384 (Okamoto, Kevin T, et. al.), notes that polymeric foam consists of voids, or cells, within a polymer matrix. Foams are typically produced by introducing a physical blowing agent into a molten polymeric stream, mixing the blowing agent with the polymer and extruding the mixture into the atmosphere while shaping the forming cells in the polymer.

There is a need in the industry for processes that produce polymeric foam having optimal mechanical properties without the presence of toxic blowing agents used in the technique represented by Okamoto such as: (1) Methylenedihphenyl diisocyanate, (2) Phenylene Diisocyanate, (3) Hexamethylene Diisocyanate, (4) Naphthalene Diisocyanate, (5) Isoporon Diisocyanate, and (6) Toluene Diisocyanate. Blowing agents are commonly carcinogenic. A blowing agent with a higher molecular weight is less likely to be airborne, and therefore less of a respiratory hazard, but the resultant foam is less uniform than that with a blowing agent of lower molecular weight.

Ligoure et. al. (“Making Polyurethane Foams from Microemulsions” Polymer 4(17):6402-6410, 8 Aug. 2005) noted the correlation between the degree of expansion of polyurethane foams and the structure of the premixes, suggesting the microemulsion of the premixes results in a better foam for many purposes, including food chemistry and biological materials. Ligoure created a microemulsion by mixing the components together and stirring in a high-speed mixer for 3 min at 10,000 tr/min.

In U.S. Pat. No. 4,012,445 (Priest et. al.), a method of preparing polymer foam utilizing beta amino carbonyl compounds as catalysts for the formation of urethane polymers by the reaction of organic isocyanates with active hydrogen-containing compounds. This method utilizes reactions between active hydrogen-containing compounds, polyisocyanates and beta amino carbonyl compounds. The resultant foam is rigid and non-pliable and therefore not well suited for buoyant marine purposes. Furthermore, this method creates a product with an unpleasant amine odor.

In U.S. Pat. No. 4,898,981 Falk, et. al., describes another method of creating synthetic polymer foam and its applications. In this method fluorinated diols are reacted with isocyanates to prepare polyurethanes. The polymeric products formed are useful for coating low energy surfaces (surfaces that do not experience high traffic volume) as well as imparting oil and water repellency qualities to textiles, glass, paper, leather and other compositions. Although this method teaches similar techniques as the present invention, the applications of the foam do not contribute to the needs of the industry. This application does not fulfill the need for a polymer foam that can be used for marine purposes.

U.S. Pat. No. 4,634,743, teaches a method of preparing polyurethanes which are then reacted with co-polymers to form a synthetic polymer foam. This method includes reacting a hydrocarbon or hydrocarbyloxyl compound with polyester or polyurethane to form a polyether polycarbonate block foam. The method taught in this patent involves a process of phosgenation in which hydrogen chloride is liberated to react with polyester to form a polyurethane resin used to create a polymer foam. This method does not satisfy the present need for buoyant polymer foams.

In U.S. Pat. No. 6,168,762, Reichman, et. al. describes the utilization of sonic energy in the foaming process to increase the absorbency of a foam. This method includes forming a reaction mixture comprising of at least one compound capable of forming a superabsorbent foam, stirring the reaction mixture, applying mechanical waves to the reaction mixture, and repeating the stirring and applying a selected number of times, thereby forming the superabsorbent foam. This method is particular to superabsorbent foam and does not address the affect of sonic energy in a closed-cell structural foam.

This process has several major drawbacks. The technical process of this method involve the preparation of materials which are expensive, difficult, time consuming to produce and hazardous. There are considerable safety issues regarding the polymers utilized in this method due to their highly corrosive nature. Furthermore, this method poses ecological implications as well. This method utilizes hydrocarbon compounds, isocyanates and polyester reacting in air. As a result the air is contaminated with hydrogen chloride gas. It is common knowledge that hydrogen chloride gas is extremely corrosive and toxic. Therefore, for the foregoing reasons, this method is neither safe, nor practical for developing a buoyant polymer foam.

### SUMMARY OF INVENTION

The present invention presents a technique for producing synthetic polymer foam. In one preferred embodiment, polyether or polyester is mixed with an isocyanate. The sonification apparatus is inserted into the polymer mixture, at which time the mixture is induced with sonic energy of about 141 Watts on a 200 Watt scale. Once the foam is of a lighter color than previously, the sonic apparatus is removed, and the foam is then poured into a mold. The sonic energy can be in the ultrasonic, subsonic, or audible ranges. Sonication is carried out by a sonifier or cell disrupter. The sound energy is between 50 Watts and 500 Watts, in a preferred embodiment the sound energy input is about 100 Watts.

In another preferred embodiment, polymer foam is created by mixing the components of foam with sound energy (sonication) before the foaming process; wherein the foam comprises catalysts, chain extenders blowing agents and pigments; wherein the foam forms as a result of a chemical reaction between the isocyanate and water. In this embodiment, the sonic energy can be in the ultrasonic, subsonic and audible. The sonication is performed by a large scale sonifier or ultrasonic (supersonic) cleaner. The sound energy frequency is of about 10 kHz and 80 kHz is used. In this preferred environment multiple ultrasonic frequencies are sequentially performed. This embodiment allows for the mixing of the polymer materials before the actual sonication process.

In the third preferred embodiment the components of the polymer foam are mixed with sonic energy during the foaming process. The sonic energy is mixed with polyol, pigment, water, and the isocyanate. In this embodiment, the ultrasonic frequencies can be at the ultrasonic, subsonic or audible level. Mixing the polymer and the sonic energy during the foaming process leads to a more streamlined, efficient process.

This invention is independent of blowing agent and has been proven to improve the cell structure of foam by reducing the cell size and creating more uniform cells throughout the foam.

### DETAILED DESCRIPTION OF THE INVENTION

Components are measured to the appropriate quantities. Most polyurethane foam premixed consist of two components, referred to as Part A and Part B, but this is not always the case. Any number of components can be used: from one single component to n components. The ratio of Part A to Part B has a direct impact on the physical properties of the foam. The sonication step can be carried out separately for pre-mixed components. This could be for several reasons: (1) premixed components may not be fully mixed (2) the additional kinetic energy could also produce the activation energy of a reaction such as partial polymerization.

Sonication is the process of applying sound energy (sonic energy) to the polymer consisting of polyether, polyester, and isocyanate. First, the tip of a sonifier/cell disruptor is inserted into the material. This tip can be one that resonates at about 20 kHz. The exact value of this resonation frequency has proven to the insignificant as two different horns with different resonances have been shown to produce the same result. The tip is turned on to a constant cycle of a sinusoidal sound wave. In order to keep the head of the reaction down, this cycle could be on a timer instead of a constant. The amplitude of the sound wave does affect the final result. Less than 7 on a 200 Watt scale ranging from 1-10 has been proven ineffective.

The tip is moved slowly throughout the medium. The entire tip must be submerged, but the tip should not touch the container. Evidence of sonication comes in the form of bubbles near the tip site and a lighter foam near the tip. When moving the tip slowly around this results in a swirl pattern in the material. This step ends when the foam is visually uniform, a lighter color than it was previous to this step. Alternatively, this step could end when the foaming reaction causes the material it be too viscous to easily move the tip around. The tip is the removed and the material may be poured.

Alternate details of this step can include having a heat-regulated container during this process. The temperature affects both the polymerization and the foaming reaction of polyurethane foam, so a controlled temperature may affect the final characteristics. Multiple sonifying tips may be used, operating at the same or different amplitudes and frequencies. Alternate methods of inputting sound energy are also possible; including ultrasonic water baths.

Because foam in liquid form has a small fraction of the volume of the expanded foam, it is often necessary to pour the foaming mixture into a larger container as it takes its final shape. A major benefit of the present invention is that the new container can be a mold in the shape of the final foam product (i.e. a surfboard). When pouring, the material has a liquid-like viscosity that may require the use of a funnel.

There are several catalysts which can be used in the sonication/synthesization process. These catalysts include amino groups, thiol groups, or carboxyl groups, but also include polyhdroxyl compounds. Examples of polyhydroxyl include polyesters, polyethers, polythioethers, polyacetals, polycarbonates, and polyester amides.

In the present invention, there are several acceptable polyester groups that could be used for this method. These groups include the reaction products of polyhydric (preferably dihydric) alcohols with the optional addition of trihydric alcohols, and polybasic (preferably dibasic) carboxylic acids. Also, polycarboxilic acids are acceptable to use in the present invention. These polycarboxilic acids include succinic acid; adipic acid; suberic acid; azelic acid; sebacic acid; phthalic acid; isophthalic acid trimellitic acid; phthalic acid anhydride, tetrahydrophtalic acid anhydride and hexahydrophtalic acid.

These catalysts and polyether groups are all acceptable chemical compounds to use in the method described for the present invention.

What is claimed:

1. A process for synthesizing polymer foam wherein the process comprises mixing components with sonic energy.

2. The method of claim 1 wherein a sonication apparatus is inserted into the polymer.

3. The method of claim 1 wherein sonication energy is at least 140 Watts.

4. The method of claim 1 wherein the sonication apparatus is removed and foam is poured.

5. The method of claim 1, wherein the process particularly useful for buoyant marine purposes.

6. The method of claim 1, wherein sonic energy is in the ultrasonic range of frequencies.

7. The method of claim 1, wherein sonic energy is in the subsonic range.

8. The method of claim 1, wherein sonic energy is in the audible range of frequencies.

9. The method of claim 1, wherein sonication is performed with a cell disrupter such as the Branson Cell Disruptor.

10. The method of claim 1, wherein sonication is performed with a large scale sonifier or ultrasonic (supersonic) cleaner.

11. The method of claim 1, wherein sound energy input of more that 100 Watts is performed.

12. The method of claim 7, wherein ultrasonic frequency of about between 10 kHz and 80 kHz is used.

13. The method of claim 14, wherein multiple ultrasonic frequencies are concurrently or sequentially performed.

14. The method of claim 2 wherein polymer foam is of a density suitable for marine purposes.

15. A process for synthesizing polymer foam utilizing sonic energy by mixing the components of foam with sound energy (sonication) before the foaming process; wherein the foam comprises catalysts, chain extenders, blowing agents and pigments; wherein the foam forms as a result of a chemical reaction between the isocyanate and water.

16. The method of claim 17 wherein sonic energy is in the ultrasonic range of frequencies.

17. The method of claim 17 wherein sonic energy is in the subsonic range of frequencies.

18. The method of claim 17 wherein sonic energy is in the audible range of frequencies.

19. The method of claim 17 wherein sonication is performed with a cell disrupter.

20. The method of claim 17 wherein sonication is performed with a large scale sonifier or ultrasonic (supersonic) cleaner.

21. The method of claim 17 wherein sound energy input of between about 50 Watts and 500 Watts is performed.

22. The method of claim 18 wherein ultrasonic frequency of about between 10 kHz and 80 kHz is used.

23. The method of claim 17 wherein multiple ultrasonic frequencies are concurrently or sequentially performed.
